(19) United States
(12) Patent Application Publication
(10) Pub. No.: US 2026/0350575 A1
(43) Pub. Date: Nov. 5, 2026

(54) METHOD AND APPARATUS FOR AUTOMATIC DATA ITEM CONFIGURATION OF PAYMENT TERMINAL, AND STORAGE MEDIUM

(71) Applicant: SHENZHEN XINGUODU TECHNOLOGY CO., LTD., Shenzhen, Guangdong (CN)

(72) Inventors: Xiaoxin ZHOU, Shenzhen (CN); Hui LIN, Shenzhen (CN)

(21) Appl. No.: 19/485,184

(22) PCT Filed: Jun. 4, 2024
(86) PCT No.: PCT/CN2024/097313

§ 371 Date: Nov. 17, 2025

(30) Foreign Application Priority Data
Jun. 7, 2023 (CN) 202310672830.8

(51) Int. Cl. G06Q 20/20

(52) U.S. Cl. CPC G06Q 20/206

(57) ABSTRACT

A method and apparatus for automatic data item configuration of a payment terminal, and a storage medium are disclosed. The method includes: acquiring payment data of a target region where the payment terminal is located, where the payment data includes a service type and a service scenario; performing feature extraction on the payment data based on the target region to obtain a service type initial feature, a service scenario initial feature, and region feature data; performing feature selection according to feature priorities to obtain a service type feature and a service scenario feature; inputting the service type feature, the service scenario feature, and the region feature data into a data item prediction model for prediction to obtain a corresponding predicted data item; and performing data item configuration on the payment terminal according to the predicted data item.

### TECHNICAL FIELD

The present disclosure relates to the technical field of payment security, and more particularly to a method and apparatus for automatic data item configuration of a payment terminal, and a storage medium.

### BACKGROUND

A Point of Sale (POS) terminal is a commonly used payment terminal, which is a device used to process electronic payments. Generally, a POS terminal has the functions of reading bank card information, inputting a consumption amount, inputting a password, confirming a payment, etc., and needs to connect to a network for communication to complete the payment process. Therefore, the payment behavior of the POS terminal involves personal privacy and account information of a user, and configuration of supervised data items of the POS terminal is of great significance to payment security.

During mass-production and deployment of POS terminals, data items need to be configured for different regions to determine the data items of the POS terminal that are to be supervised, to ensure the security of payment behavior. However, due to different regulatory requirements in different regions, different data items need to be configured for different regions. In related technologies, the data item configuration process usually requires manual participation, which is cumbersome and is prone to configuration errors or omissions. Moreover, adaptive configuration and management cannot be achieved. Consequently, much time and manpower are required.

### SUMMARY

The present disclosure aims to at least solve one of the technical problems in the related art. Therefore, embodiments of the present disclosure provide a method and apparatus for automatic data item configuration of a payment terminal, and a storage medium, which can automatically configure data items of the payment terminal according to features of different regions, thereby optimizing the configuration process and reducing manual intervention and the configuration time.

In accordance with a first aspect of the present disclosure, an embodiment provides a method for automatic data item configuration of a payment terminal, including:
acquiring payment data of a target region where the payment terminal is located, where the payment data includes a service type and a service scenario;
performing feature extraction on the payment data based on the target region to obtain a service type initial feature, a service scenario initial feature, and region feature data;
performing feature selection on the service type initial feature and the service scenario initial feature according to feature priorities to obtain a service type feature and a service scenario feature;
inputting the service type feature, the service scenario feature, and the region feature data into a data item prediction model for prediction to obtain at least one predicted data item; and
performing data item configuration on the payment terminal according to the predicted data item.

In some embodiments of the present disclosure, the performing feature extraction on the payment data based on the target region to obtain a service type initial feature, a service scenario initial feature, and region feature data further includes:
performing text processing on the payment data to obtain payment text information;
extracting a region name, a service type, and a service scenario from the payment text information based on the target region; and
vectorizing the region name to obtain the region feature data, vectorizing the service type to obtain the service type initial feature, and vectorizing the service scenario to obtain the service scenario initial feature.

In some embodiments of the present disclosure, the data item prediction model is a supervised model; and before the inputting the service type feature, the service scenario feature, and the region feature data into a data item prediction model for prediction to obtain at least one predicted data item, the method further includes:
training the data item prediction model, including:
   acquiring samples and labels of the samples to form a training dataset, and obtaining a label vector of each sample, where the sample includes historical region feature data, a historical service type feature, and a historical service scenario feature, and the label includes at least one of patch version, device International Mobile Equipment Identity (IMEI) information, payment application version, security software development kit (SDK) version, device geographical location, device real-time clock (RTC) time, system runtime, installed application information, permission application information, application startup timestamp, customer application package name, or customer application signature;
   inputting the sample into an initial data item prediction model for prediction to obtain a data item prediction result, where the data item prediction result includes a predicted label;
   converting the predicted label into a vector representation to obtain a predicted vector;
   calculating an evaluation indicator according to the predicted vector and the corresponding label vector to obtain an indicator value; and
   adjusting a model weight of the initial data item prediction model according to an indicator threshold and the indicator value until an iteration condition is satisfied, to obtain the data item prediction model.

In some embodiments of the present disclosure, the evaluation indicator includes at least one of precision, a recall rate and an F1 value, and the calculating an evaluation indicator according to the predicted vector and the corresponding label vector to obtain an indicator value includes:
when the evaluation indicator is the precision, the indicator value is calculated using the following formula: P=TP/(TP+FP);
when the evaluation indicator is the recall rate, the indicator value is calculated using the following formula: R=TP/(TP+FN); and
when the evaluation indicator is the F1 value, the indicator value is calculated using the following formula: F1=2PR/(P+R),
where TP represents a number of true positives, FP represents a number of false positives, and FN represents a number of false negatives.

In some embodiments of the present disclosure, after the performing data item configuration on the payment terminal according to the predicted data item, the method further includes:
acquiring updated data of the target region in response to the payment data satisfying a preset change condition;
inputting the updated data into the data item prediction model for prediction to obtain an updated predicted data item; and
performing a data item configuration update on the payment terminal according to the updated predicted data item.

In some embodiments of the present disclosure, determining that the payment data satisfies the preset change condition includes:
acquiring new payment data at every preset period;
comparing the new payment data with the payment data to obtain a degree of difference; and
determining that the payment data satisfies the preset change condition, in response to the degree of difference satisfying a preset degree of difference.

In some embodiments of the present disclosure, after the performing data item configuration on the payment terminal according to the predicted data item, the method further includes:
acquiring and saving data item data corresponding to each of the at least one predicted data item;
obtaining data change information based on the data item data and the payment data;
obtaining an uploading policy for the predicted data item according to the data change information and a pre-trained policy prediction model, where the policy prediction model is an unsupervised model and is configured for adaptively adjusting the uploading policy for the predicted data item; and
based on the uploading policy, selecting the corresponding predicted data item in the payment terminal and uploading the selected predicted data item to a target platform.

In some embodiments of the present disclosure, after the performing data item configuration on the payment terminal according to the predicted data item, the method further includes:
interpreting the predicted data item to obtain interpretation information;
visualizing the interpretation information to obtain a visualization result; and
sending the visualization result to a target object, where the target object includes at least one of a bank, a payment terminal provider, and a payment institution.

In accordance with a second aspect of the present disclosure, an embodiment provides an apparatus for automatic data item configuration of a payment terminal, which is configured to implement the method for automatic data item configuration of a payment terminal according to any one of the embodiments of the first aspect of the present disclosure, and includes:
a data acquisition module configured for acquiring payment data of a target region where the payment terminal is located, where the payment data includes a service type and a service scenario;
a feature extraction model configured for performing feature extraction on the payment data based on the target region to obtain a service type initial feature, a service scenario initial feature, and region feature data;
a feature selection module configured for performing feature selection on the service type initial feature and the service scenario initial feature according to feature priorities to obtain a service type feature and a service scenario feature;
a data item prediction module configured for inputting the service type feature, the service scenario feature, and the region feature data into a data item prediction model for prediction to obtain at least one predicted data item; and
a data item configuration module configured for performing data item configuration on the payment terminal according to the predicted data item.

In accordance with a third aspect of the present disclosure, an embodiment further provides an electronic device, including a memory and a processor, where the memory is configured for storing a computer program which, when executed by the processor, causes the processor to implement the method for automatic data item configuration of a payment terminal according to any one of the embodiments of the first aspect of the present disclosure.

In accordance with a fourth aspect of the present disclosure, an embodiment further provides a computer-readable storage medium, having a program stored therein, where the program, when executed by a processor, causes the processor to implement the method for automatic data item configuration of a payment terminal according to any one of the embodiments of the first aspect of the present disclosure.

The embodiments of the present disclosure at least include the following beneficial effects.

The embodiments of the present disclosure provide a method and apparatus for automatic data item configuration of a payment terminal, and a storage medium. The method includes: acquiring payment data of a target region where the payment terminal is located, where the payment data includes a service type and a service scenario; then performing feature extraction on the payment data based on the target region to obtain a service type initial feature, a service scenario initial feature, and region feature data; then performing feature selection on the service type initial feature and the service scenario initial feature according to feature priorities to obtain a service type feature and a service scenario feature; then inputting the service type feature, the service scenario feature, and the region feature data into a data item prediction model for prediction to obtain at least one predicted data item; and finally performing data item configuration on the payment terminal according to the predicted data item. As such, feature extraction and feature selection are performed on the payment data of the target region to obtain corresponding feature data, and data items of the payment terminal can be automatically configured by inputting the feature data into a pre-trained data item prediction model. The payment data includes supervision requirement data of a corresponding region, so that adaptive automatic configuration can be performed on the payment terminal for different regions, thereby optimizing the configuration process and reducing manual intervention and the configuration time.

Other aspects and advantages of the present disclosure will be given in the following description, some of which will become apparent from the following description or may be learned from practices of the present disclosure.

### BRIEF DESCRIPTION OF DRAWINGS

The above and/or other additional aspects and advantages of the present disclosure become apparent and comprehensible from the description of embodiments in combination with accompanying drawings, in which:

FIG. 1 is a schematic flowchart of a method for automatic data item configuration of a payment terminal according to an embodiment of the present disclosure;

FIG. 2 is a schematic flowchart of S102 in FIG. 1;

FIG. 3 is a schematic flowchart before S104 in FIG. 1;

FIG. 4 is a schematic flowchart after S105 in FIG. 1;

FIG. 5 is a schematic flowchart of S401 in FIG. 1;

FIG. 6 is another schematic flowchart after S105 in FIG. 1;

FIG. 7 is still another schematic flowchart after S105 in FIG. 1;

FIG. 8 is a schematic block diagram of an apparatus for automatic data item configuration of a payment terminal according to an embodiment of the present disclosure; and

FIG. 9 is a schematic structural diagram of an electronic device according to an embodiment of the present disclosure.

Reference numerals: data acquisition module 100, feature extraction model 200, feature selection module 300, data item prediction module 400, data item configuration model 500, electronic device 1000, processor 1001, memory 1002.

### DETAILED DESCRIPTION

To make the objectives, technical schemes, and advantages of the present disclosure clearer, the present disclosure is described in further detail in conjunction with accompanying drawings and embodiments. It is to be understood that the specific embodiments described herein are merely used for illustrating the present disclosure, and are not intended to limit the present disclosure.

Embodiments of the present disclosure will be described in detail hereinafter in conjunction with accompanying drawings in which the same or like reference characters refer to the same or like elements or elements having the same or like functions throughout. The embodiments described below by reference to the accompanying drawings are illustrative and are intended for illustrating only and are not to be construed as limiting of the present disclosure.

In the description of the present disclosure, it should be understood that for the description of orientations, the orientation or positional relationships indicated by the terms such as “up,” “down,” “front,” “rear,” “left,” “right,” and the like are based on orientation or positional relationships shown in the accompanying drawings, and are used only for ease and brevity of illustration and description, rather than indicating or implying that the mentioned apparatus or element must have a particular orientation or must be constructed and operated in a particular orientation. Therefore, such terms should not be construed as limiting of the present disclosure.

It should be understood that in the description of the embodiments of the present disclosure, the term “at least one” means one or more, the term “plurality of” (or multiple) means at least two, the term such as “greater than”, “less than”, “exceed” or variants thereof prior to a number or series of numbers is understood to not include the number adjacent to the term. The term “at least” prior to a number or series of numbers is understood to include the number adjacent to the term “at least”, and all subsequent numbers or integers that could logically be included, as clear from context. If used herein, the terms such as “first”, “second”, and the like are merely used for distinguishing technical features, and are not intended to indicate or imply relative importance, or implicitly point out the number of the indicated technical features, or implicitly point out the precedence order of the indicated technical features.

In the description of the present disclosure, unless otherwise explicitly defined, the terms such as “configure”, “install/mount” and “connect” should be understood in a broad sense, and those having ordinary skills in the art can reasonably determine the specific meanings of the above terms in the present disclosure based on the specific contents of the technical scheme.

A Point of Sale (POS) terminal is a commonly used payment terminal, which is a device used to process electronic payments and is widely used in supermarkets, restaurants, hotels, shopping malls, and other retail industries and other related fields. Generally, a POS terminal has the functions of reading bank card information, inputting a consumption amount, inputting a password, confirming a payment, etc., and needs to connect to a network for communication to complete the payment process. Therefore, the payment behavior of the POS terminal involves personal privacy and account information of a user, and configuration of supervised data items of the POS terminal is of great significance to payment security.

During mass-production and deployment of POS terminals, data items need to be configured according to laws and regulations, policy requirements, industry standards, security requirements, etc. of different regions to determine the data items of the POS terminal that are to be supervised, to ensure the security of payment behavior. However, due to different regulatory requirements in different regions, different data items need to be configured for different regions. In related technologies, the data item configuration process usually requires manual participation. For example, a data item table and a region table are designed through a database, and then multiple regions and multiple data items are associated through an association table, indicating that different regions may have the same data items. However, the process is cumbersome and is prone to configuration errors or omissions, and adaptive configuration and management cannot be achieved for different regions. Consequently, much time and manpower are required. In addition, as the business environment changes, data items to be stored by and supervised for POS terminals will also change, and configuration information needs to be frequently updated.

Based on this, embodiments of the present disclosure provide a method and apparatus for automatic data item configuration of a payment terminal, and a storage medium. The method includes: acquiring payment data of a target region where the payment terminal is located, where the payment data includes a service type and a service scenario; then performing feature extraction on the payment data based on the target region to obtain a service type initial feature, a service scenario initial feature, and region feature data; then performing feature selection on the service type initial feature and the service scenario initial feature according to feature priorities to obtain a service type feature and a service scenario feature; then inputting the service type feature, the service scenario feature, and the region feature data into a data item prediction model for prediction to obtain at least one predicted data item; and finally performing data item configuration on the payment terminal according to the predicted data item. As such, feature extraction and feature selection are performed on the payment data of the target region to obtain corresponding feature data, and data items of the payment terminal can be automatically configured by inputting the feature data into a pre-trained data item prediction model. The payment data includes supervision requirement data of a corresponding region, so that adaptive automatic configuration can be performed on the payment terminal for different regions, thereby optimizing the configuration process and reducing manual intervention and the configuration time.

The method and apparatus for automatic data item configuration of a payment terminal, and the storage medium provided in the embodiments of the present disclosure will be described in detail through the following embodiments. The method for automatic data item configuration of a payment terminal in the embodiments of the present disclosure is described first.

The method for automatic data item configuration of a payment terminal in the embodiments of the present disclosure relates to the technical field of payment security, and more particularly to the technical field of security of payment terminals. The method for automatic data item configuration of a payment terminal in the embodiments of the present disclosure may be applied to a terminal or a server, or may be a computer program in a terminal or a server. For example, the computer program may be a native program or software module in an operating system; and may be a native application (APP), i.e., a program that can be run only after being installed in an operating system, e.g., a client that supports generation of a network attack rule graph, i.e., a program that can be run when downloaded to a browser environment. In summary, the computer program may be any form of application program, module, or plug-in. A terminal communicates with a server through a network. The method for automatic data item configuration of a payment terminal may be executed by a terminal or a server, or jointly by a terminal and a server.

In some embodiments, the terminal may be a smartphone, a tablet computer, a notebook computer, a desktop computer, a smartwatch, or the like, but is not limited thereto. The server may be an independent server, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform, or may be a service node in a blockchain system. Service nodes in the blockchain system form a peer-to-peer (P2P) network. The P2P protocol is an application layer protocol that runs over the Transmission Control Protocol (TCP) protocol. A server-side component of a network attack rule map generation system may be installed on the server, and the server can interact with the terminal. For example, corresponding software is installed on the server-side component, and the software may be an application implementing a network attack rule map generation method, etc., but is not limited to the above form. The terminal and the server may be connected by a communication connection method such as Bluetooth, Universal Serial Bus (USB), or a network, which is not limited in the embodiments of the present disclosure.

The present disclosure may be used in a wide variety of general purpose or special purpose computer system environments or configurations, for example, personal computers (PCs), server computers, handheld or portable devices, tablet-type devices, multiprocessor systems, microprocessor-based systems, set-top boxes, programmable consumer electronic devices, network PCs, midrange computers, mainframe computers, distributed computing environments including any of the above systems or devices, etc. The present disclosure may be described in the general context of computer-executable instructions executed by a computer, for example, program modules. Generally, the program modules include routines, programs, objects, components, data structures, and the like for performing specific tasks or implementing specific abstract data types. The present disclosure may also be practiced in distributed computing environments in which tasks are performed by remote processing devices connected through a communication network. In a distributed computing environment, program modules may be located in local and remote computer storage media, including storage devices.

The method for automatic data item configuration of a payment terminal in the embodiments of the present disclosure will be described below. It can be understood that using a POS terminal as an example of the payment terminal is not intended to limit the present disclosure, and the payment terminal may also be a mobile payment terminal, a self-service payment terminal, an unmanned payment terminal, or the like, which is not limited in the present disclosure.

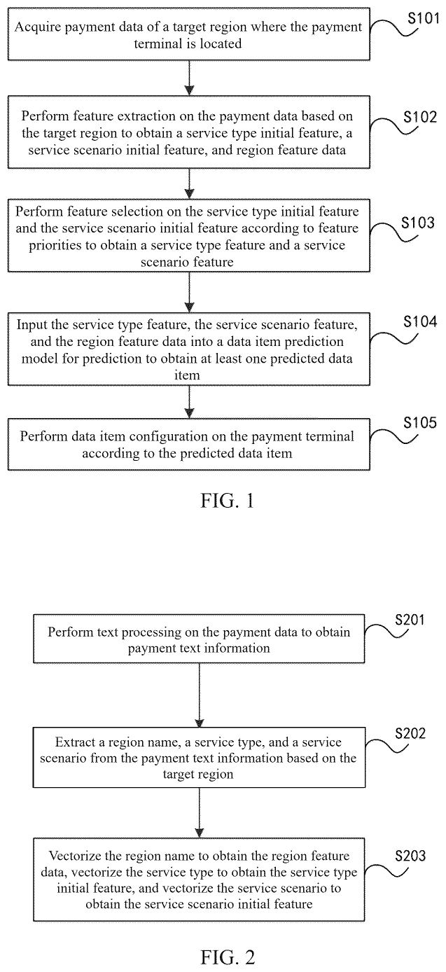

Referring to FIG. 1, an embodiment of the present disclosure provides a method for automatic data item configuration of a payment terminal, which includes, but not limited to, the following steps S101 to S105.

At S101, payment data of a target region where the payment terminal is located is acquired.

In some embodiments, the payment data includes a service type and a service scenario. For example, the service scenario may be online payment or offline payment. The online payment is payment made through the Internet, such as online shopping, mobile phone payment, etc. The offline payment is payment made in a physical store or other places, such as payment with a POS terminal, quick response (QR) code payment, etc. The service type includes bank card payment, third-party payment, mobile payment, electronic wallet, etc. The bank card payment is payment made through a bank card, such as a credit card, a debit card, etc. The third-party payment is payment made through a third-party payment platform, such as Alipay, WeChat Pay, etc. The mobile payment is payment made through a mobile device, such as payment with a mobile phone, payment with a smart band, etc. The electronic wallet is virtual currency stored in an electronic device, such as a JD.com wallet, a Baidu wallet, etc., which is not limited in the embodiments of the present disclosure.

It can be understood that the payment data may also include data related to payment security. For example, payment data of a POS terminal may further include: a transaction amount, which is the total amount of the current transaction, including commodity price, taxes, service fees, etc.; a transaction type, which is the type of the current transaction, such as consumption, refund, cancellation, etc.; transaction time, which is the time of occurrence of the current transaction, including the date and specific time; a merchant number, which is a unique identifier registered by a merchant with a bank or payment institution and is used for identifying an identity of the merchant; a terminal number, which is a unique identifier of the POS terminal and is used for identifying the transaction terminal; a transaction status, which is the status of the current transaction, such as successful transaction, failed transaction, etc.; a transaction serial number, which is a unique identifier of the current transaction and is used for querying and tracking transaction records; a card number, which is card number information of a payment made through a bank card; and a transaction reference number, which is a unique identifier assigned by a bank or payment institution for the current transaction and is used for querying and tracking transaction records, etc., which is not limited in the embodiments of the present disclosure.

At S102, feature extraction is performed on the payment data based on the target region to obtain a service type initial feature, a service scenario initial feature, and region feature data.

In some embodiments, for payment behavior, relevant payment data needs to be stored and supervised according to requirements of different regions to ensure payment security. It can be understood that as different regions have different laws and regulations, policy requirements, payment security industry standards, and security requirements, different data items to be supervised are set for POS terminals in different regions.

In some embodiments, the payment data further includes laws and regulations, related policies, industry standards, security requirements, etc. of different countries and regions. It can be understood that the acquired payment data is only related to payment security, so that the cost and complexity of data collection are reduced, and data items related to payment security can be captured more accurately, thereby improving the accuracy and reliability of data. Therefore, feature extraction is performed on payment data based on a target region, and different service type initial features, service scenario initial features, and region feature data are extracted for different regions.

In some embodiments, the feature extraction process includes the following operations: 1. Determination of the service type: A payment service is classified according to factors such as a payment service object, a payment method, and a transaction environment. For example, payment methods may be classified into different categories such as online payment and offline payment. 2. Extraction of feature variables: For each service type and service scenario, related feature variables are extracted from the dataset. These variables may include user information, transaction time, transaction amount, payment method, product attribute, etc., and should be able to reflect the details of the payment service. This is not limited in the embodiments of the present disclosure.

It can be understood that the feature extraction process may further include feature transformation and feature dimensionality reduction to improve feature discrimination and classification performance. Commonly used feature transformation methods include principal component analysis (PCA), linear discriminant analysis (LDA), local linear embedding (LLE), etc. Feature dimensionality reduction is an operation of using a dimensionality reduction algorithm to convert high-dimensional data to low-dimensional data, making the data more processable and easier to understand, and reducing computational costs and overfitting, which is not limited in the embodiments of the present disclosure.

At S103, feature selection is performed on the service type initial feature and the service scenario initial feature according to feature priorities to obtain a service type feature and a service scenario feature.

In some embodiments, both the service type initial feature and the service scenario initial feature have a plurality of pieces of feature data, and the most relevant feature may be selected from the service type initial feature and the service scenario initial feature as the service type feature and the service scenario feature according to feature priorities. For example, different feature subsets are generated according to different feature selection algorithms. Then, appropriate feature evaluation criteria, such as information gain, correlation coefficient, chi-squared test, mutual information, etc. are selected to sort the features in the feature subsets, to determine the importance and contribution of the features. Then, an appropriate feature subset is selected according to the feature evaluation criteria and the result of feature sorting to retain main information and discrimination, thus obtaining the corresponding service type feature and service scenario feature.

For example, the user information, transaction information, and device information corresponding to the payment terminal are highly correlated and have an important contribution to the security monitoring of the payment behavior, and therefore will be selected as the corresponding service type feature and service scenario feature, which is not limited in the embodiments of the present disclosure.

At S104, the service type feature, the service scenario feature, and the region feature data are inputted into a data item prediction model for prediction to obtain at least one predicted data item.

In some embodiments, the service type feature, the service scenario feature, and the region feature data are inputted into a data item prediction model for prediction. It can be understood that the data item prediction model is a pre-trained machine learning model, which perform classification prediction according to feature data inputted according to regulatory requirements of different regions, to obtain at least one predicted data item. Specifically, the predicted data item may be: transaction data, including information such as transaction amount, transaction time, transaction location, transaction type, etc.; merchant data, including information such as merchant name, merchant address, merchant type, merchant number, etc.; terminal data, including information such as terminal number, terminal type, terminal location, terminal status, etc.; security data, including information such as transaction encryption, identity verification, security authentication, password management, etc.; or regulatory data, including information such as regulatory institution, regulatory rule, regulatory standard, regulatory report, etc. The predicted data item may also be patch version, device IMEI information, payment application version, security SDK version, device geographical location, device RTC time, system runtime, installed application information, permission application information, application startup timestamp, customer application package name, customer application signature, etc., which is not limited in the embodiments of the present disclosure.

At S105, data item configuration is performed on the payment terminal according to the predicted data item.

In some embodiments, data items are automatically configured for the payment terminal according to the obtained predicted data items. For example, for a region A, after feature extraction and feature selection are performed on payment data including laws and regulations, policies, industry standards, and security requirements of the region A, the obtained feature data is inputted to a data item prediction model for prediction. When the obtained predicted data items include transaction data, merchant data, regulatory data, and security SDK version, data item configuration is automatically performed for the POS terminal in the region A, to configure the above predicted data items as data items to be stored by and supervised for POS terminals. For another example, for a region B, after feature extraction and feature selection are performed by inputting payment data including laws and regulations, policies, industry requirements, and security standards of the region B, the obtained feature data is inputted into a data item prediction model. When the obtained predicted data items include merchant data, regulatory data, device geographical location, and permission application information, data item configuration is automatically performed for the POS terminal in the region B, to configure the above predicted data items as data items to be stored by and supervised for POS terminals. This is not limited in the embodiments of the present disclosure.

As such, feature extraction and feature selection are performed on the payment data of the target region that includes laws and regulations, policies, etc. to obtain corresponding feature data, and data items of the payment terminal can be automatically configured by inputting the feature data into a pre-trained data item prediction model. Therefore, adaptive automatic configuration can be performed on the payment terminal for different regions, thereby optimizing the configuration process and reducing manual intervention and the configuration time.

Referring to FIG. 2, in some embodiments of the present disclosure, S102 may further include, but is not limited to, the following steps S202 to S203.

At S201, text processing is performed on the payment data to obtain payment text information.

In some embodiments, the feature extraction process includes performing text processing on the payment data to obtain payment text information. The payment data may be processed using libraries such as pandas and NumPy in python, including at least one of missing value handling, outlier handling, and data standardization. The missing value handling is to fill or delete missing values in the payment data. The outlier handling is to replace or delete outliers in the payment data. The data standardization is to perform standardization processing on the payment data based on a preset data standard format, for example, perform unified processing and conversion of data of different data sources, different formats, and different structures. As such, the text processing on the payment data can eliminate data redundancy, improve data quality, reduce the data processing complexity, and make data easier to analyze and share, which is not limited in the embodiments of the present disclosure.

At S202, a region name, a service type, and a service scenario are extracted from the payment text information based on the target region.

In some embodiments, a region name, a service type, and a service scenario are extracted from the payment text information based on the target region. The region name may be extracted from a region code of the target region, or may be extracted from a geographical coordinate location of the target region, or may be extracted by keyword matching, to obtain the corresponding service type and service scenario, which is not limited in the embodiments of the present disclosure. For example, the payment data may be acquired from a policy document published by a relevant website or data source of the target region, and after text processing is performed on the payment data, the region name, the service type, and the service scenario may be extracted. For example, relevant content of a policy document of the region A reads: “According to the policy of the Ministry of Commerce of the region A, foreign enterprises that sell or provide services within the region A must register with the local commerce bureau and obtain a service license. In addition, foreign enterprises also need to comply with tax policies and labor regulations of the region A. During the registration process, it is necessary to provide detailed information of the company, including but not limited to company name, registered address, legal representative information, etc. ,” and correspondingly, the extracted content is: “Region Name: Region A; Business Type: Commercial Policy; Business Scenario: Registration and Business License Application for Foreign Enterprises Selling or Providing Services in Region A; Other Payment Data: Company Name, Registered Address,” which is not limited in the embodiments of the present disclosure.

At S203, the region name is vectorized to obtain the region feature data, the service type is vectorized to obtain the service type initial feature, and the service scenario is vectorized to obtain the service scenario initial feature.

In some embodiments, the region name, the service type, and the service scenario are vectorized to obtain the region feature data, the service type initial feature, and the service scenario initial feature. For example, the vectorization is performed through natural language processing. For example, one-hot encoding is used to encode each word or character in the text into a one-hot vector, i.e., a vector with only one element being 1 and other elements being 0. The one-hot vectors of all words or characters form a matrix, i.e., a feature vector. The vectorization may also be performed using a bag-of-words model, Word2Vec, or other methods, which is not limited in the embodiments of the present disclosure.

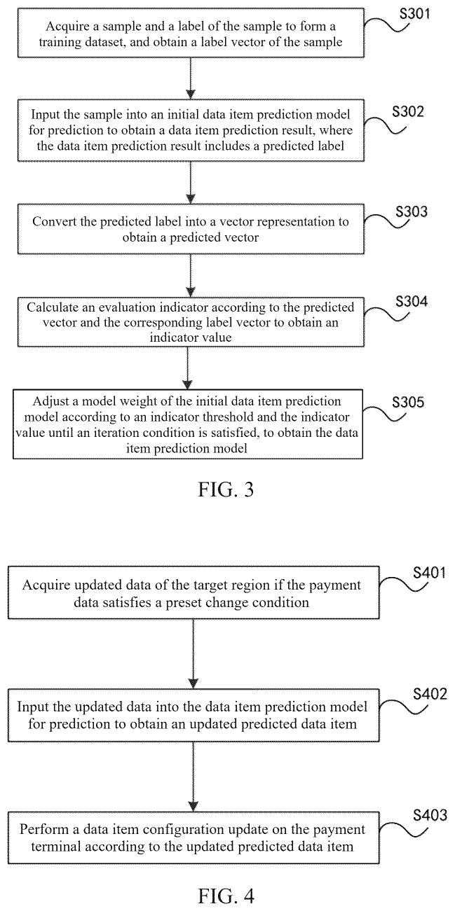

Referring to FIG. 3, in some embodiments of the present disclosure, before S104, the method further includes training the data item prediction model. Training the data item prediction model may further include, but is not limited to, the following steps S301 to S305.

At S301, samples and labels of the samples are acquired to form a training dataset, and a label vector of each sample is obtained.

In some embodiments, the samples are obtained by feature extraction and feature selection of historical payment data of different regions, and include historical region feature data, historical service type features, and historical service scenario features of different regions, and also includes laws and regulations, policies, industry standards, safety requirements, etc. corresponding to different regions, which is not limited in the embodiments of the present disclosure.

In some embodiments, the label in the sample is a multi-label, and the label includes at least one of patch version, device IMEI information, payment application version, security SDK version, device geographical location, device RTC time, system runtime, installed application information, permission application information, application startup timestamp, customer application package name, or customer application signature.

It can be understood that the label is key information to classify or categorize data, each sample corresponds to a label, and the label vector represents each label as a vector, where each dimension of the vector represents a specific attribute or category of the label. For example, if a sample A includes merchant data and security SDK version, the corresponding merchant data and security SDK version in the label vector of the sample A are both 1, i.e., [1, 1], and if a sample B does not include merchant data and includes only secure SDK version, the corresponding merchant data in the label vector of the sample B is 0, and the corresponding secure SDK version in the label vector of the sample B is 1, i.e., [0, 1], which is not limited in the embodiments of the present disclosure.

At S302, the sample is inputted into an initial data item prediction model for prediction to obtain a data item prediction result, where the data item prediction result includes a predicted label.

In some embodiments, the initial data item prediction model and the data item prediction model are supervised models. For example, the initial data item prediction model is a logistic regression model. Logistic regression is a machine learning model widely used in classification problems, and is a linear classification model that predicts a label of a new sample by learning a relationship between features and labels of samples. It can be understood that the output of the logistic regression model is a probability value indicating the probability that the sample belongs to a label, i.e., a data item prediction result including a predicted label is obtained.

In some embodiments, the data item prediction model may be a decision tree model, a random forest model, a neural network model, etc., which may be set by those having ordinary skills in the art according to actual requirements and is not limited in the embodiments of the present disclosure.

At S303, the predicted label is converted into a vector representation to obtain a predicted vector.

In some embodiments, the predicted label is converted into a vector representation to obtain a predicted vector. Converting labels into vectors is a commonly used method for multi-label classification. The conversion may be implemented using binary encoding or one-hot encoding. It can be understood that because the output of the logistic regression model is the probability of the label, a probability threshold may be set. The label whose probability is greater than or equal to the probability threshold is set to 1, the label whose probability is less than the probability threshold is set to 0, and then the labels are converted into a vector representation. For example, the probability threshold may be 0.3 or 0.5, which may be set by those having ordinary skills in the art according to actual requirements and is not limited in the embodiments of the present disclosure.

At S304, an evaluation indicator is calculated according to the predicted vector and the corresponding label vector to obtain an indicator value.

In some embodiments, an evaluation indicator may be calculated according to the predicted vector of the sample and the corresponding label vector. It can be understood that the indicator value obtained by calculating the evaluation indicator may be used to evaluate the performance and accuracy of the initial data item prediction model, to improve and optimize the model and improve the prediction performance and generalization performance of the model.

In some embodiments, the evaluation indicator includes at least one of precision, a recall rate and an F1 value. When the evaluation indicator is the precision, the indicator value is calculated using the following formula: P=TP/(TP+FP), where TP represents a number of true positives, i.e., a number of samples that are correctly predicted by the model as positives and whose labels are also positives. For example, if a label “security SDK version” of a sample A is a positive and the “security SDK version” corresponding to the predicted label is also a positive, the sample A is a true positive. FP represents a number of false positives, i.e., a number of samples that are erroneously predicted by the model as positives but whose labels are negatives. For example, if a label “permission application information” of a sample B is a positive example and the “permission application information” corresponding to the predicted label is a negative, the sample B is a false positive. When the evaluation indicator is the recall rate, the indicator value is calculated using the following formula: R=TP/(TP+FN), where FN represents a number of false negatives, i.e., a number of samples that are erroneously predicted by the model as negatives but whose labels are positives. For example, a label “patch version” of a sample C is negative, but the “patch version” corresponding to the predicted label is positive, the sample C is a false negative. When the evaluation indicator is the F1 value, the indicator value is calculated using the following formula: F1=2PR/(P+R). The evaluation indicator may also be a regression error, accuracy, a receiver operating characteristic (ROC) curve, an area under the curve (AUC) value, etc., which is not limited in the embodiments of the present disclosure.

It can be understood that the precision can reflect the accuracy of classification as positives, and the recall rate can reflect the ability of the model to identify positives, and the F1 value is a harmonic average of the precision and the recall rate, which comprehensively considers the classification accuracy and the identification ability of the model. Therefore, the higher the value of the evaluation indicator, the closer it is to 1, and the higher the prediction performance of the model.

At S305, a model weight of the initial data item prediction model is adjusted according to an indicator threshold and the indicator value until an iteration condition is satisfied, to obtain the data item prediction model.

In some embodiments, a model weight of the initial data item prediction model is further adjusted by comparing the indicator threshold with the indicator value. For example, when the indicator threshold is 0.8 and the indicator value is 0.6, it means that the prediction performance and generalization performance of the initial data item prediction model are subpar, and the initial data item prediction model cannot correctly predict data items to be configured for the POS terminal. Therefore, the initial data item prediction model needs to be adjusted. Adjustment of the model weight is improving the prediction performance and generalization performance of the model by changing parameter weights in the model. In machine learning, commonly used weight adjustment methods include gradient descent, stochastic gradient descent, Newton method, etc. For example, gradient descent is a commonly used weight adjustment method. Its basic idea is to update the parameter weights of the model along a gradient of a loss function, so that the loss function is continuously reduced. The loss function is minimized by continuous iteration, to optimize the parameter weights of the model until an iteration condition is met. For example, when the indicator value meets the indicator threshold, the initial data item prediction model is used as the final data item prediction model.

Referring to FIG. 4, in some embodiments of the present disclosure, after S105, the method may further include, but is not limited to, the following steps S401 to S403.

At S401, updated data of the target region is acquired if the payment data satisfies preset change condition.

In some embodiments, because changes in the economic situation, political factors, and international trade situation may have an important impact on enterprises and consumers, a government needs to adjust and optimize its commercial policies to adapt to the new economic and social environment. Therefore, laws, regulations, policies, industry requirements, and security standards on business in different countries and regions may also change. Correspondingly, if the payment data of the target region meets a preset change condition, updated data of the target region is acquired.

At S402, the updated data is inputted into the data item prediction model for prediction to obtain an updated predicted data item.

In some embodiments, feature extraction and feature selection are performed on the updated data to obtain an updated region data feature, an updated service type feature, and an updated service scenario feature, which are inputted into the data item prediction model for prediction to obtain an updated predicted data item.

At S403, a data item configuration update is performed on the payment terminal according to the updated predicted data item.

In some embodiments, a data item configuration update is performed on the payment terminal according to the updated predicted data item, to adapt to the new economic and social environment and ensure the security of payment behavior based on legal compliance.

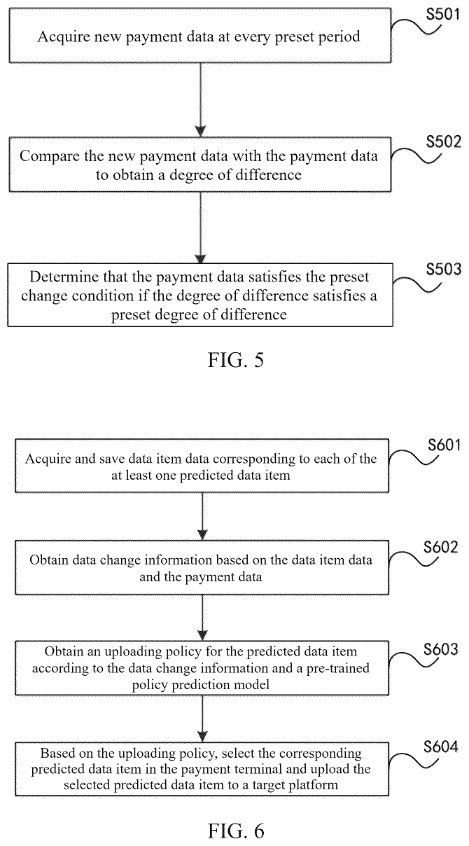

Referring to FIG. 5, in some embodiments of the present disclosure, S401 may further include, but is not limited to, the following steps S502 to S503.

At S501, new payment data is acquired at every preset period.

In some embodiments, a preset period may be set, which may be three months or six months, and new payment data corresponding to the region, including laws and regulations, policies, industry standards, security requirements, etc. of the region, is acquired at every preset period, which may be set by those having ordinary skills in the art according to actual requirements and is not limited in the embodiments of the present disclosure.

At S502, the new payment data is compared with the payment data to obtain a degree of difference.

In some embodiments, the new payment data is compared with the payment data. example, the new payment data is subjected to the same data processing as the payment data, e.g., missing value handling, outlier handling, data standardization. Then, feature extraction is performed. A text similarity between the new payment data and the payment data is calculated, and a degree of difference between the new payment data and the payment data is obtained through further analysis and comparison using a method such as keyword extraction.

At S503, it is determined that the payment data satisfies the preset change condition the degree of difference satisfies a preset degree of difference.

In some embodiments, a preset degree of difference is set, which may be 0.1 or 0.15. If the calculated degree of difference is greater than or equal to the preset degree of difference, it is determined that the payment data satisfies the preset change condition, the configuration of data items needs to be updated.

Referring to FIG. 6, in some embodiments of the present disclosure, after S105, the method may further include, but is not limited to, the following steps S601 to S604.

At S601, data item data corresponding to each of the at least one predicted data item is acquired and saved.

In some embodiments, when the payment terminal is in use, the payment terminal acquires and records relevant data for each payment behavior, mainly including transaction amount, transaction time, transaction type, card number, terminal number, merchant number, transaction status, etc., and data item data corresponding to each predicted data item is further saved to a database of the payment terminal. For example, the data item data is saved in a relational database, such as MySQL, Oracle, etc., to ensure the integrity and consistency of data, which is not limited in the embodiments of the present disclosure.

At S602, data change information is obtained based on the data item data and the payment data.

In some embodiments, data change information is obtained based on the data item data and the payment data, i.e., changes of data in different time periods are analyzed. The payment data includes historical data item data. A time series analysis method may be adopted. Time series analysis is a method of modeling, predicting, and analyzing time series data, which is conducive to analyzing the patterns and trends of the time series data and predict the future trend and amplitude of change of the time series data. This is not limited in the embodiments of the present disclosure.

At S603, an uploading policy for the predicted data item is obtained according to the data change information and a pre-trained policy prediction model.

In some embodiments, an uploading policy for the predicted data item is obtained according to the data change information and a pre-trained policy prediction model, where the pre-trained policy prediction model is an unsupervised model. For example, feature extraction and feature selection are performed on the data change information, and then the obtained feature data is inputted to the policy prediction model for prediction to obtain an uploading policy for the predicted data item corresponding to the payment terminal. For example, if there are ten types of predicted data items stored in the database of the payment terminal, but only six types of predicted data items are included in the uploading policy, data item data corresponding to the six types of predicted data items is determined as the uploading policy.

At S604, based on the uploading policy, the corresponding predicted data item in the payment terminal is selected and uploaded to a target platform.

It can be understood that because authentication and monitoring centers of different regions supervise different data items of payment terminals, the data item data corresponding to the predicted data item of the payment terminal needs to be uploaded on the premise of legal compliance. For example, based on the uploading policy, the corresponding predicted data item in the payment terminal is selected, and data item data in the corresponding predicted data item is uploaded to a target platform. The target platform may be a related cloud platform or monitoring platform, etc.

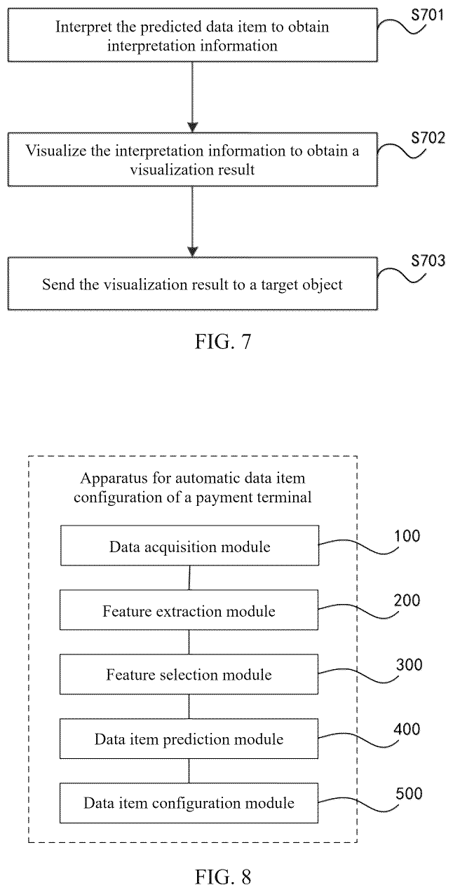

Referring to FIG. 7, in some embodiments of the present disclosure, after S105, the method may further include, but is not limited to, the following steps S701 to S703.

At S701, the predicted data item is interpreted to obtain interpretation information.

In some embodiments, interpreting the predicted data item is a process of converting data information into understandable information. The interpretation information includes analyzing a basis and necessity of using the predicted data item, legality of the predicted data item in the region, security of the authentication process, etc., helping relevant personnel to understand and adjust.

At S702, the interpretation information is visualized to obtain a visualization result.

In some embodiments, the interpretation information is visualized. An information type is determined first, and then a visualization type is selected. An appropriate visualization type is selected according to a data type and an analysis goal. For example, the visualization may be performed using a chart, a report, a graph, etc., which is not limited in the embodiments of the present disclosure.

At S703, the visualization result is sent to a target object.

In some embodiments, the target object includes at least one of a bank, a payment terminal provider, a payment institution, and other stakeholders, which is not limited in the embodiments of the present disclosure.

An embodiment of the present disclosure further provides an apparatus for automatic data item configuration of a payment terminal, which can implement the method for automatic data item configuration of a payment terminal. Referring to FIG. 8, in some embodiments of the present disclosure, the apparatus for automatic data item configuration of a payment terminal includes:
a data acquisition module 100 configured for acquiring payment data of a target region where the payment terminal is located, where the payment data includes a service type and a service scenario;
a feature extraction model 200 configured for performing feature extraction on the payment data based on the target region to obtain a service type initial feature, a service scenario initial feature, and region feature data;
a feature selection module 300 configured for performing feature selection on the service type initial feature and the service scenario initial feature according to feature priorities to obtain a service type feature and a service scenario feature;
a data item prediction module 400 configured for inputting the service type feature, the service scenario feature, and the region feature data into a data item prediction model for prediction to obtain at least one predicted data item; and
a data item configuration module 500 configured for performing data item configuration on the payment terminal according to the predicted data item.

Specific embodiments of the apparatus for automatic data item configuration of a payment terminal according to the embodiments of the present disclosure are basically the same as the specific embodiments of the method for automatic data item configuration of a payment terminal, so the details will not be repeated herein.

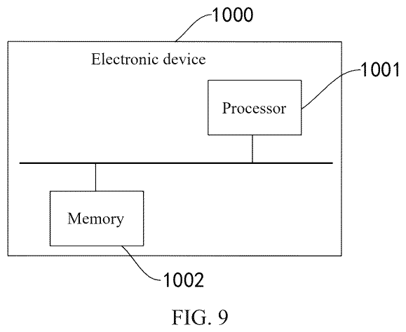

FIG. 9 shows an electronic device 1000 according to an embodiment of the present disclosure. The electronic device 1000 includes a processor 1001, a memory 1002, and a computer program stored in the memory 1002 and executable by the processor 1001. The computer program, when run, is configured for executing the method for automatic data item configuration of a payment terminal.

The processor 1001 and the memory 1002 may be connected by a bus or in other ways.

The memory 1002, as a non-transitory computer-readable storage medium, may be configured for storing a non-transitory software program and a non-transitory computer-executable program, for example, the method for automatic data item configuration of a payment terminal described in the embodiments of the present disclosure. The processor 1001 runs the non-transitory software program and instruction stored in the memory 1002, to implement the method for automatic data item configuration of a payment terminal.

The memory 1002 may include a program storage area and a data storage area. The program storage area may store an operating system, and an application required by at least one function. The data storage area may store data and the like required for executing the method for automatic data item configuration of a payment terminal. In addition, the memory 1002 may include a high speed random access memory, and may also include a non-transitory memory, e.g., at least one magnetic disk storage device, flash memory device, or other non-transitory solid-state storage device. In some implementations, the memory 1002 optionally includes memories 1002 located remotely from the processor 1001, and the remote memories 1002 may be connected to the electronic device 1000 via a network. Examples of the network include, but are not limited to, the Internet, an intranet, a local area network, a mobile communication network, and combinations thereof.

The non-transitory software program and instructions required to implement the method for automatic data item configuration of a payment terminal are stored in the memory 1002, and when executed by one or more processors 1001, execute the method for automatic data item configuration of a payment terminal, for example, execute the method steps S101 to S105 in FIG. 1, the method steps S201 to S203 in FIG. 2, the method steps S301 to S305 in FIG. 3, the method steps S401 to S403 in FIG. 4, the method steps S501 to S503 in FIG. 5, the method steps S601 to S604 in FIG. 6, or the method steps S701 to S703 in FIG. 7.

An embodiment of the present disclosure further provides a storage medium, which is computer-readable storage medium and stores a computer program which, when executed by a processor, causes the processor to implement the method for automatic data item configuration of a payment terminal. The memory, as a non-transitory computer-readable storage medium, may be configured for storing a non-transitory software program and a non-transitory computer-executable program. In addition, the memory may include a high-speed random access memory, and may also include a non-transitory memory, e.g., at least one magnetic disk storage device, flash memory device, or other non-transitory solid-state storage device. In some implementations, the memory may include memories located remotely from the processor, and the remote memories may be connected to the processor via a network. Examples of the network include, but are not limited to, the Internet, an intranet, a local area network, a mobile communication network, and combinations thereof.

The embodiments of the present disclosure provide a method and apparatus for automatic data item configuration of a payment terminal, a device, and a storage medium. The method includes: acquiring payment data of a target region where the payment terminal is located, where the payment data includes a service type and a service scenario; then performing feature extraction on the payment data based on the target region to obtain a service type initial feature, a service scenario initial feature, and region feature data; then performing feature selection on the service type initial feature and the service scenario initial feature according to feature priorities to obtain a service type feature and a service scenario feature; then inputting the service type feature, the service scenario feature, and the region feature data into a data item prediction model for prediction to obtain at least one predicted data item; and finally performing data item configuration on the payment terminal according to the predicted data item. As such, feature extraction and feature selection are performed on the payment data of the target region to obtain corresponding feature data, and data items of the payment terminal can be automatically configured by inputting the feature data into a pre-trained data item prediction model. The payment data includes supervision requirement data of a corresponding region, so that adaptive automatic configuration can be performed on the payment terminal for different regions, thereby optimizing the configuration process and reducing manual intervention and the configuration time.

The embodiments of the present disclosure also have the following advantages.

1. Optimization of data source input: The data source input process in the embodiments of the present disclosure is optimized for payment security, and only data items related to payment security are collected, thereby reducing the cost and complexity of data collection. Compared with a data collection method in which there may be a large number of irrelevant data items in the related art, according to the embodiments of the present disclosure, data items related to payment security can be captured more accurately, thereby improving the accuracy and reliability of data.

2. Optimization of data cleaning and processing: The data preprocessing process in the embodiments of the present disclosure can better remove missing data, remove outliers, standardize data, and so on, thereby improving the quality of data. This can better improve the efficiency and accuracy of data processing in cases where there may be unstable data quality and large noise interference in the related art.

3. Data item interpretation and visualization: The data item interpretation and visualization in the embodiments of the present disclosure can show, interpret, and analyze the predicted data items in an easy-to-understand and visualized manner, thereby improving the interpretability and visualization degree of the data items. As such, the ability to analyze payment security can be better improved, providing strong support for the safe development of the payment industry.

The embodiments described above are merely illustrative. The units described as separate components may or may not be physically separated, i.e., they may be located in one place or may be distributed over a plurality of network units. Some or all of the modules may be selected according to actual needs to achieve the objectives of the schemes of the embodiments of the present disclosure.

Those having ordinary skills in the art can understand that all or some of the steps in the methods and system disclosed above can be implemented as software, firmware, hardware, and appropriate combinations thereof. Some or all physical components may be implemented as software executed by a processor, such as a central processing unit, a digital signal processor, or a microprocessor, or as hardware, or as an integrated circuit, such as an application-specific integrated circuit. Such software may be distributed on a computer-readable medium, which may include a computer storage medium (or non-transitory medium) and a communication medium (or transitory medium). As is known to those having ordinary skills in the art, the term “computer storage medium” includes volatile and nonvolatile, removable and non-removable media implemented in any method or technology for storage of information (such as computer-readable instructions, data structures, program modules, or other data). The computer storage medium includes, but not limited to, a Random Access Memory (RAM), a Read-Only Memory (ROM), an Electrically Erasable Programmable Read-Only Memory (EEPROM), a flash memory or other memory technology, a Compact Disc Read-Only Memory (CD-ROM), a Digital Versatile Disc (DVD) or other optical storage, a cassette, a magnetic tape, a magnetic disk storage or other magnetic storage device, or any other medium which can be used to store the desired information and which can be accessed by a computer. In addition, as is known to those having ordinary skills in the art, the communication medium typically includes computer-readable instructions, data structures, program modules, or other data in a modulated data signal such as a carrier or other transport mechanism, and can include any information passing medium.

It should also be understood that the various implementations provided by the embodiments of the present disclosure may be arbitrarily combined to achieve different technical effects. Although some embodiments of the present disclosure have been described above, the present disclosure is not limited to the implementations described above. Those having ordinary skills in the art can make various equivalent modifications or replacements without departing from the scope of the present disclosure.

1. A method for automatic data item configuration of a payment terminal, comprising:
acquiring payment data of a target region where the payment terminal is located, wherein the payment data comprises a service type and a service scenario;
performing feature extraction on the payment data based on the target region to obtain a service type initial feature, a service scenario initial feature, and region feature data;
performing feature selection on the service type initial feature and the service scenario initial feature according to feature priorities to obtain a service type feature and a service scenario feature;
inputting the service type feature, the service scenario feature, and the region feature data into a data item prediction model for prediction to obtain at least one predicted data item; and
performing data item configuration on the payment terminal according to the predicted data item.

2. The method for automatic data item configuration of a payment terminal of claim 1, wherein the performing feature extraction on the payment data based on the target region to obtain a service type initial feature, a service scenario initial feature, and region feature data further comprises:
performing text processing on the payment data to obtain payment text information;
extracting a region name, a service type, and a service scenario from the payment text information based on the target region; and
vectorizing the region name to obtain the region feature data, vectorizing the service type to obtain the service type initial feature, and vectorizing the service scenario to obtain the service scenario initial feature.

3. The method for automatic data item configuration of a payment terminal of claim 1, wherein the data item prediction model is a supervised model; and before the inputting the service type feature, the service scenario feature, and the region feature data into a data item prediction model for prediction to obtain at least one predicted data item, the method further comprises:
training the data item prediction model, comprising:
acquiring a sample and a label of the sample to form a training dataset, and obtaining a label vector of the sample, wherein the sample comprises historical region feature data, a historical service type feature, and a historical service scenario feature, and the label comprises at least one of patch version, device International Mobile Equipment Identity (IMEI) information, payment application version, security software development kit (SDK) version, device geographical location, device real-time clock (RTC) time, system runtime, installed application information, permission application information, application startup timestamp, customer application package name, or customer application signature;
inputting the sample into an initial data item prediction model for prediction to obtain a data item prediction result, wherein the data item prediction result comprises a predicted label;
converting the predicted label into a vector representation to obtain a predicted vector;
calculating an evaluation indicator according to the predicted vector and the corresponding label vector to obtain an indicator value; and
adjusting a model weight of the initial data item prediction model according to an indicator threshold and the indicator value until an iteration condition is satisfied, to obtain the data item prediction model.

4. The method for automatic data item configuration of a payment terminal of claim 3, wherein the evaluation indicator comprises at least one of precision, a recall rate and an F1 value, and the calculating an evaluation indicator according to the predicted vector and the corresponding label vector to obtain an indicator value comprises:
when the evaluation indicator is the precision, the indicator value is calculated using the following formula: P=TP/(TP+FP);
when the evaluation indicator is the recall rate, the indicator value is calculated using the following formula: R=TP/(TP+FN); and
when the evaluation indicator is the F1 value, the indicator value is calculated using the following formula: F1=2PR/(P+R),
wherein TP represents a number of true positives, FP represents a number of false positives, and FN represents a number of false negatives.

5. The method for automatic data item configuration of a payment terminal of claim 1, wherein after the performing data item configuration on the payment terminal according to the predicted data item, the method further comprises:
acquiring updated data of the target region in response to the payment data satisfying a preset change condition;
inputting the updated data into the data item prediction model for prediction to obtain an updated predicted data item; and
performing a data item configuration update on the payment terminal according to the updated predicted data item.

6. The method for automatic data item configuration of a payment terminal of claim 5, wherein determining that the payment data satisfies the preset change condition comprises:
acquiring new payment data at every preset period;
comparing the new payment data with the payment data to obtain a degree of difference; and
determining that the payment data satisfies the preset change condition, in response to the degree of difference satisfying a preset degree of difference.

7. The method for automatic data item configuration of a payment terminal of claim 1, wherein after the performing data item configuration on the payment terminal according to the predicted data item, the method further comprises:
acquiring and saving data item data corresponding to each of the at least one predicted data item;
obtaining data change information based on the data item data and the payment data;
obtaining an uploading policy for the predicted data item according to the data change information and a pre-trained policy prediction model, wherein the policy prediction model is an unsupervised model and is configured for adaptively adjusting the uploading policy for the predicted data item; and
based on the uploading policy, selecting the corresponding predicted data item in the payment terminal and uploading the selected predicted data item to a target platform.

8. The method for automatic data item configuration of a payment terminal of claim 1, wherein after the performing data item configuration on the payment terminal according to the predicted data item, the method further comprises:
interpreting the predicted data item to obtain interpretation information;
visualizing the interpretation information to obtain a visualization result; and
sending the visualization result to a target object, wherein the target object comprises at least one of a bank, a payment terminal provider, and a payment institution.

9. An apparatus for automatic data item configuration of a payment terminal comprising:
a data acquisition module configured for acquiring payment data of a target region where the payment terminal is located, wherein the payment data comprises a service type and a service scenario;
a feature extraction model configured for performing feature extraction on the payment data based on the target region to obtain a service type initial feature, a service scenario initial feature, and region feature data;
a feature selection module configured for performing feature selection on the service type initial feature and the service scenario initial feature according to feature priorities to obtain a service type feature and a service scenario feature;
a data item prediction module configured for inputting the service type feature, the service scenario feature, and the region feature data into a data item prediction model for prediction to obtain at least one predicted data item; and
a data item configuration module configured for performing data item configuration on the payment terminal according to the predicted data item.

10. A non-transitory computer-readable storage medium, having a program stored therein, wherein the program, when executed by a processor, causes the processor to perform the method for automatic data item configuration of a payment terminal of claim 1.
